(19) United States
(12) Patent Application Publication
(10) Pub. No.: US 2026/0285751 A1
(43) Pub. Date: Sep. 24, 2026

(54) MICROPOROUS POWDER COMPOSITION, USE THEREOF AND INSULATION PRODUCT

(71) Applicant: PRTC NV, Tisselt (BE)

(72) Inventor: Oras ABDUL-KADER, Sint Niklaas (BE)

(21) Appl. No.: 19/469,535

(22) PCT Filed: Mar. 28, 2024
(86) PCT No.: PCT/EP2024/058692

§ 371 Date: Sep. 26, 2025

(30) Foreign Application Priority Data
Mar. 31, 2023 (EP) 23166012.7
Feb. 6, 2024 (EP) 24155931.9

(51) Int. Cl. C04B 14/36; C04B 14/42; C04B 30/00; C04B 103/56; F16L 59/02

(52) U.S. Cl. CPC C04B 14/365; C04B 14/42; C04B 30/00; F16L 59/026; C04B 2103/56

(57) ABSTRACT

The microporous powder composition, comprising an insulation powder chosen from alumina and silica, and an opacifier and a filler, wherein the filler is a gypsum material. The gypsum material may be gypsum dihydrate, gypsum hemihydrate or gypsum anhydrite. It may be synthetic gypsum or natural gypsum or a combination of both. The microporous powder composition comprises the opacifier in an amount of 10-50 wt %, the insulation powder in an amount of 30-60 wt % and the filler in an amount of 1-50 wt %. The microporous powder composition is used in insulation products in the form of panels and insulation blankets.

### FIELD OF THE INVENTION

The invention relates to a microporous powder composition, comprising an insulation powder chosen from alumina and silica, an opacifier and a filler.

The invention further relates to an insulation product comprising a microporous powder composition, which insulation product is a panel or a blanket.

The invention moreover relates to the use of a microporous powder composition for the manufacture of an insulation product.

### BACKGROUND OF THE INVENTION

Microporous insulation materials are known per se, for instance from GB1580909 and U.S. Pat. No. 6,936,326, and comprise a porous silica material which generally is either a pyrogenic silica or aerogel, and in addition thereto an opacifier and optionally a reinforcing fiber. In ASTM C168, microporous insulation is defined as “material in the form of compacted powder or fibres with an average interconnecting pore size comparable or below the mean free path of air molecules at standard atmospheric pressure. Microporous insulation may contain opacifiers to reduce the amount of radiant heat transmitted”. Microporous materials are characterized by a very low thermal conductivity of less than 40 mW/m.K, especially at 400° C., and even significantly lower and are often used as thin insulating panel in a variety of industrial applications as well as in construction. The temperature of 400° C. is for many applications more relevant than room temperature. Additionally, the shrinkage after 24 hours heating at 900° C. is an important parameter. This should be less than 5.0%, and preferably lower. In the context of the present application, reference will be made to a microporous powder composition as a synonym for a microporous insulation material.

Microporous insulation materials may be used in the form of a panel, an insulation blanket, as shaped insulation components, and as a granulate. An overview can be found in the product brochure “High temperature microporous insulation” of Promat International NV, dated May 2014. As apparent therefrom, the panels may have a different degree of flexibility, which is also due to the type of encapsulation and shaping. The microporous insulation materials may be encapsulated in a rigid or flexible envelope. The microporous material may alternatively be provided within a barrier material which is then drawn to vacuum. The latter panel is known per se as a vacuum insulation panel or VIP.

WO00/37389A1 discloses microporous powder compositions comprising (synthetic) xonotlite, a specific type of calcium silicate, in addition to pyrogenic silica, opacifier, an optional inorganic fiber and an optional inorganic binder material. The addition of this specific porous and crystalline calcium silicate material improves the flexural strength of the panels and blankets formed from such powder compositions. However, the thermal conductivity performance is not very good, especially at higher temperatures. The parallel application WO00/37388A1 of the same applicant provides thermal conductivity date for a microporous powder composition comprising 63 wt % pyrogenic silica, 30 wt % rutile opacifier, 2 wt % silica fibers with a length of 6 mm and 5 wt % synthetic xonotlite. At 600° C., the thermal conductivity is 40 mW/mk and at 800° C., it is 48 mW/mK, while at 200° C. merely 28 mW/mK. In comparison, the thermal conductivity of a panel with less performant E-glass fibers is 31 mW/mK at 600° C., 39 mW/mK at 800° C. and 23 mW/mK at 200° C. (as reported on page 29 of the brochure of Promat International). Hence, at 600° C., the increase in thermal conductivity is about 30%. This is significant for a key performance indicator.

Microporous powder compositions for the preparation of granulates are known from WO2006/097668A1. The disclosed compositions are fiber-free, as fibers result in relatively large voids between the granules. Such relatively large voids (as compared to the microporous voids within a microporous powder) would cause the thermal conductivity of the resulting material to be high relative to large continuous bodies of comparable insulation. The granulates were prepared on the basis of a powder composition comprising 30-95% dry weight microporous insulating material (i.e. pyrogenic silica), 5-70% dry weight infrared opacifying material, 0-50% particulate insulating filler material, and 0-5% binder material. Examples of particulate insulating filler materials are vermiculite, perlite, flyash, volatilized silica and mixtures thereof. These materials are silica- and silica-based materials, with SiO₂ contents of 36-42%, 70-75%, 40-55% and 100%. Vermiculite, perlite and flyash moreover contain significant amounts of alumina. Overall, these renders the particulate filler materials similar in chemical composition to the basic material of the microporous powder composition, i.e. pyrogenic silica and pyrogenic alumina. Still, the addition of 12% thereof had a significant effect on the shrinkage after a 24 hours heat treatment at 900° C. Without filler this shrinkage was less than 2.0%. With volatilized silica as filler, it was 5.5% When using 12% of precipitated silica, it was even 7.1%. The effect on the thermal conductivity of the granulates was limited, but the value thereof was with 40 mW/mK at 400° C. still high.

In recent times, price of raw materials have increased significantly, with the risk that the insulation performance of microporous insulation products in the form of panels and blankets no longer justifies the price setting of these specific products. It would be desirable to arrive at a microporous powder composition with sufficiently low thermal conductivity, an acceptable shrinkage after 24 hours heating at 900° C. and with an acceptable price, which is suitable for the manufacture of panels and insulation blankets.

### SUMMARY OF THE INVENTION

It is therefore a first object of the invention to provide an improved microporous powder composition, which is suitable for generation of panels and blankets and has a sufficiently low thermal conductivity at a temperature of 400° C. and higher, and an acceptable shrinkage after a 24 hour heat treatment at 900° C. Especially, the thermal conductivity at 400° C. is to be less than 40 mW/mK, and preferably at most 36 mW/mK. The said shrinkage is in particular less than 5% and preferably less than 4% or even less than 3%.

It is another object of the invention to provide a method of manufacturing insulation products in the form of panels or blankets using the improved microporous powder composition.

It is a further object of the invention to provide insulation products in the form of panels or blankets comprising the improved microporous powder composition.

According to a first aspect, the invention provides a microporous powder composition, comprising an insulation powder chosen from alumina and silica, an opacifier, a reinforcing fiber and a filler, wherein the filler is a gypsum material.

According to a second aspect, the invention provides use of the microporous powder composition of the invention for the manufacture of insulation products.

According to a third aspect, the invention relates a method of manufacturing of an insulation product, comprising the steps of (1) providing the microporous powder composition of the invention (2) compressing or compacting said microporous powder composition and (3) processing said microporous powder composition into an insulation product.

According to a fourth aspect, the invention relates to insulation products comprising the microporous powder composition of the invention.

It has been observed in experiments that gypsum is very suitable as filler for a microporous powder composition. It has little impact on performance with good processing or even improved processing of the powder composition, such as during mixing, compaction or compression.

In a preferred embodiment, at least part of the crystalline gypsum material is crystalline gypsum. More preferably, the crystalline material is predominantly needle-shaped, thus comprising at least 30 vol %, such as at least 40 vol % needle-shaped crystalline material. Needle-shaped material is deemed most beneficial as a processing aid during compression or compaction of the microporous powder composition.

In another embodiment, use is made of gypsum material with a mean size (d50) in the range of 10-100 μm as measured with laser diffraction. More preferably, the mean size (d50) is in the range of 20-75 μm. Good results have been obtained with gypsum having a mean size (d50) in the range of 30-50 μm. It is surprising that a combination of fine, microporous material with comparatively big gypsum particles provide good results with respect to insulation performance. It is observed herein that microporous material typically has a primary particle size of typically a few nanometers. The primary particles constitute aggregates including microporous voids in the order of 100 nm. The opacifier is also typically at least partially present in the sub-micrometer range. The inventor believes, without desiring to be bound therewith, that the combination of such large gypsum particles with fine silica material results in a specific order or microstructure within the material. For instance, an encapsulation of the gypsum particles may be formed, resulting therein that the individual gypsum particles are isolated from each other, and as a consequence that the thermal conductivity is defined by the microporous phase in the material. Such understanding is deemed supported by the measured thermal conductivities and also the small shrinkage after a heat treatment.

In a further implementation, the gypsum material has an aspect ratio of length to width of at most 5. The width is herein seen as the smallest size, such that the aspect ratio is necessarily at least one. In a preferred implementation the aspect ratio is at most 3. Such a shape is deemed beneficial for processing of the material.

In one embodiment, the gypsum material is or comprises predominantly (in a minimum weight percentage of 60%, preferably 70% or 80% or even 90% with respect to the total amount of gypsum), gypsum dihydrate, when provided as a fresh product. Gypsum dihydrate is a conventional form of gypsum material with formula CaSO₄.2H₂O. Gypsum dihydrate has a needle-shaped crystal shape. The use of needle-shaped crystalline material is deemed positive, as it may stabilize the powder composition during a compaction or compression step during the processing. It is known that gypsum dihydrate has limited temperature stability, but processing of microporous powder mixtures typically occurs without any specific heating, thus at room temperature or slightly above. Moreover, if during operation temperatures go up and the dihydrate may convert into other hydrates such as the hemihydrate or the anhydrate, the liberated water does not cause trouble, as it may be partially absorbed by other ingredients of the powder composition, such as the insulation powder which is preferably silica. Moreover, such liberated water may evaporate and remove out of the insulation product, particularly when the insulation product is not present in a package constituting a barrier for water vapour.

In another embodiment, the gypsum material is or predominantly comprises (in a minimum weight percentage of 60%, preferably 70% or 80% or even 90% with respect to the total amount of gypsum), gypsum hemihydrate, when provided as a fresh product. Gypsum hemihydrate is known under the formula CaSO₄.0.5H₂O. It is not excluded that during operation the gypsum hemihydrate may convert into another hydrate, such as anhydrate. Gypsum hemihydrate has temperature stability up to at least 400° C., and even beyond when dispersed in a powder mixture. This enables that the material is stable up during most operation temperatures, and therewith that no changes will occur that might have any impact on the insulation performance, particularly some change in the thermal conductivity. Gypsum hemihydrate is moreover available in a needle-shaped crystal form, particularly the so-called alpha-form, which is deemed beneficial for processing. Moreover, any out-diffusion of water vapour is limited in compared to the gypsum dihydrate, as the hemihydrate contains only one fourth of the water as the dihydrate.

In again another form, gypsum material is or predominantly comprises (in a minimum weight percentage of 60%, preferably 70% or 80% or even 90% with respect to the total amount of gypsum), gypsum anhydrite. This anhydrite has very good temperature stability, in line with the temperature stability of microporous powders. It will not covert to another hydrate under liberation of water. Hence, this anhydrate is suitable for use in insulation products comprising a barrier that does not allow out-diffusion of water vapour, and also in substantial amounts, for instance at least 10% based on the weight of the microporous powder composition.

It is observed for sake of clarity that the wording of predominant composition of the gypsum is used, as any supplied gypsum material may include some further hydrate forms in addition to the main one present. In a further embodiment, however, mixtures of the dihydrate, hemihydrate and anhydrite forms of gypsum may be used. Such a mixture may achieve improved temperature stability of the thermal conductivity in combination with the presence of sufficient needle-shaped crystals that may support processing. Furthermore, the water vapour generation may be limited.

Preferably, the gypsum material is used in a purity of at least 80% by weight. Being a natural material, gypsum may comprise other ingredients than calcium sulphate. Both for sake of minimizing the impact on the insulation performance and for sake of avoiding any unexpected processing issues, it is preferable to limit the amount of other ingredients. More preferably, the gypsum material is used in the microporous powder composition with a purity of at least 90% by weight, or even with a purity of at least 95% by weight. A preferred source of such gypsum material is so-called synthetic gypsum, which results from industrial product, particularly as a by-product of other industrial processes. The most common and preferred form of synthetic gypsum is FGD gypsum, formed from coal-fired power plants and more particularly by means of flue gas desulfurization. However, synthetic gypsum can also be generated through various acid-neutralizing processes. Additional types of synthetic gypsum include titanogypsum, phosphogypsum, fluorogypsum, and citrogypsum. Natural gypsum, and/or any gypsum waste material from a gypsum dry wall manufacturing plant, may alternatively be used.

In one embodiment, the gypsum filler is present in an amount of 1 to 50 weight percent, based on total dry weight of the microporous powder composition. At the lower end of the range, for 1-10 weight percent, such as 3-8% by weight, and for instance 5 wt %, the gypsum filler turns out to have small to almost negligible effect on the thermal conductivity at 400° C. and the shrinkage after 24 hour heat treatment at 900° C. At a higher end of the range, typically from 20-50 weight percent, the addition leads to a significant decrease in cost price without a corresponding decrease in loss of insulation performance. As a compromise, in a further embodiment, the gypsum filler is present in an amount of 10 to 25 weight percent, such as in the range of 10-20 wt. %, based on total dry weight of the microporous powder composition. This presence of gypsum may be effective for cost price reduction without significant effect on the performance, especially the insulation performance.

Preferably, the gypsum filler material will reduce the amount of insulation powder without reduction of the amount of opacifier. However, at a higher end of the range, some reduction of the amount of opacifier may be foreseen.

In one implementation, gypsum is the only filler that is used in the microporous powder composition. In a further implementation, other fillers may be used as part of the microporous powder composition. Some examples of these fillers are for instance calcium silicate and perlite. A preferred porous version of calcium silicate is synthetic xonotlite. Preferred versions of perlite are expanded perlite and perlite microspheres. Alkaline-earth hydroxides and alkaline hydroxides may be added, for facilitation of a steam curing treatment if so desired. Preferably, such further fillers are present in an amount not exceeding the amount of the gypsum material and more preferably less than the gypsum filler. The total amount of any other filler is preferably at most 10% by weight, more preferably at most 5% by weight.

While the insulation powder, the opacifier and the reinforcing fiber are known ingredients for a microporous powder composition, some observations are made in the following.

In one embodiment, at least 50% by weight of the insulation powder is chosen from the group selected from pyrogenic silica, pyrogenic alumina or combinations thereof. Preferably, at least 80% by weight of the insulation powder is chosen from the group selected from pyrogenic silica, pyrogenic alumina or combinations thereof. Moreover, the amount of non-pyrogenic forms of silica or alumina, such as precipitated silica, microsilica and silica fuse, is at most 50% by weight and preferably at most 20% by weight. Such non-pyrogenic forms of silica may be suitable for products intended for use at lower temperatures, for instance up to 300° C., but the insulation performance quickly deteriorates upon heating. When the amount of non-pyrogenic forms of silica and alumina is at most 20%, insulation performance can be preserved. In such case, thermal conductivity will increase, but generally less than 10% increase. The temperature limit, i.e. the maximum temperature at which the material may be used without significant deterioration is comparable. Of all non-pyrogenic forms of silica, precipitated silica is most preferred, since it has a comparatively large specific surface area and presence of micropores is assumed. Preferably, at least 90% by weight of the insulation powder is chosen from the group of pyrogenic silica, pyrogenic alumina or combinations thereof. Pyrogenic silica is the name for pyrogenically prepared silicic acids. Alumina, if used, is preferably prepared analogously. Pyrogenic alumina is in use as a very high-temperature version, with temperature stability exceeding 1100° C., whereas pyrogenic silica is the standard version. It follows from the examples that the gypsum addition works both for pyrogenic silica and for pyrogenic alumina. In a further preferred implementation, the insulation powder is pyrogenic silica. It is for instance present in an amount of 30 to 90 weight percent, and preferably 40 to 80 weight percent, based on total dry weight of the microporous powder composition. Microporous powder compositions comprising pyrogenic silica may have a temperature stability up to 1000° C., and have been found appropriate for granulation. If a temperature stability to higher temperatures would be desired, alumina is to be added or used. Particle sizes of the insulation powder is for instance between 2 and 300 nanometers, with a particle size between 4 and 100 nm being more common and a particle size between 4 and 20 nm most common.

Opacifiers for use in microporous powder compositions are known, and for instance include titanium oxide, ilmenite, iron (II), iron (III) mixed oxides, chromium dioxide, zirconium oxide, manganese oxide, iron oxide, aluminium oxide, zirconium silicate, silicon carbide. Zirconium silicate, silicon carbide and titanium oxide, especially in the rutile form, are preferred opacifiers. The opacifier is preferably present in an amount in the range of 10-50% by weight, more preferably 15-40% by weight. In case that silicon carbide is the opacifier, an amount of 15-30 wt %, for instance 20-25 wt % is deemed preferred. In case that rutile or zirconium silicate are used as opacifier, an amount of 25-40% by weight is preferred, such as 30-40 wt %.

Reinforcing fiber are conventionally used to strengthen panel- or block-shape type insulation products. Reinforcing fibers may further be useful to increase the flexibility thereof. Reinforcing fibers may be inorganic fibers or organic fibers such carbon fibers, cellulose fibers, polyethylene fibers, viscose fibers, polypropylene fibers. Reinforcing fibers are preferably inorganic fibers which have better high temperature stability than organic fibers. They are conventionally chosen from glass fibers, basalt fibers, ceramic fibers, such as silica fibers, alumina fibers and alkaline earth fibers (also known as body soluble fibers). Most preferred are silica fibers and glass fibers. EP1663907B1 discloses a series of glass and alumina fibers and their chemical composition. Reinforcing fibers are for instance present in amounts of up to 15% by weight, such as at least 0.1% by weight, preferably in the range of 1 to 8% by weight, more preferably 3-5% by weight. Preferred length are in the range from 3 to 12 mm, such as for instance 6 or 8 mm. Preferred diameter is up to 15 μm, for instance 4-10 μm. It is not excluded that a mixture of fibers is applied, such as a mixture of glass fibers and ceramic fibers, especially silica fibers. It has been observed experimentally, that the mere replacement of glass fibers by silica fibers reduces the thermal conductivity at 400° C., and furthermore diminishes its increase upon addition of gypsum material. Moreover, this replacement increases the bending strength. A mixture of fibers is considered as a beneficial compromise between optimal performance and cost-price.

In one implementation, the microporous powder composition comprises the opacifier in an amount of 10-50 wt %, the insulation powder in an amount of 40-80 wt % and said filler in an amount of 1-50 wt %. More preferably, the microporous powder composition comprises the opacifier in an amount of 20-40 wt %, the insulation powder in an amount of 30-60 wt % and said filler in an amount of 5-30 wt %. The reinforcing fiber is preferably present in an amount of at most 5 wt %.

According to the invention, the microporous powder composition is used for the manufacture of a panel or an insulation blanket. In one embodiment, the insulation product is in the form of a panel. Such panels are important products comprising microporous powder compositions, and exist in various grades and types, depending on the desired temperature stability as well as the envelope, including a possible barrier so as to produce a vacuum insulation panel. Panels may be subdivided into rigid panels and flexible panels. The degree of flexibility depends among others on the layer thickness and the encapsulation, including its manufacture. Known product types of flexible panels include slatted panels, overstitched panels and quilted panels. An insulation blanket is a very flexible form of a panel that comes in the form of rolls, and is able to cover areas in a blanket-like manner. A preferred envelope is woven glass cloth, but non-woven cloth and even organic cloth can be used alternatively, depending on customer requirements. Further reference can be made to product catalogues and information leaflets. Based on investigations and optimizations so far, it is believed that the maximum amount of gypsum filler can be higher for a rigid panel than for a flexible panel, and further dependent on the degree of flexibility. For insulation blankets, the preferred amount may be up to 20% by weight, for less flexible panels such as quilted panels or overstitched panels, the preferred amount may be in the range of 10-25% by weight, and for rigid panels, the preferred amount may be from 20 to 40% by weight.

Optionally, a water-repellent and/or hydrophobation agent may be applied for control of humidity level. The application may be as part of the powder composition. The water-repellent or hydrophobic agent may further be applied during or directly subsequent to manufacture of the—pyrogenic-silica, i.e. so as to use hydrophobic pyrogenic silica and/or hydrophobic pyrogenic alumina exclusively or in combination with (hydrophilic) pyrogenic silica and/or (hydrophilic) pyrogenic alumina. Examples of agents are siloxanes, waxes and silicone resins, the latter typically provided in the form of an emulsion in water.

It is observed for clarity that any of the embodiments discussed hereinabove, specified in dependent claims and/or apparent from the examples are deemed applicable to any of the aspects of the invention. Parameter values given in the present specification are measured in accordance with the methods specified hereinbelow, unless otherwise indicated or known per se. Any reference to the weight percentage herein expressed as wt. % or % by weight refers to the same. The reference is the total powder composition, which is a dry composition, unless otherwise indicated.

### EXAMPLES

These and other aspects of the invention will be further elucidated in following examples.

### Measurement Methods

Compressive strength is measured in following manner: granules are pressed into a metal die. A universal test machine of 500 kN load cell is used with cross head speed of 1 mm/min. The maximum force and displacement are recorded continuously during compression and the stress is calculated therefrom.

Tap or tapped density is an increased bulk density attained after mechanically tapping a receptacle containing the sample of powder. The tapped bulk density is obtained by mechanically tapping a graduated measuring cylinder or vessel containing the sample. After observing the initial untapped bulk volume (V0) and mass (m0) of the sample, the measuring cylinder or vessel is mechanically tapped, and volume or mass readings are taken until little further volume or mass change is observed. The mechanical tapping is achieved by raising the cylinder or vessel and allowing it to drop, under its own mass, a specified distance. Devices that rotate the cylinder or vessel during tapping may be preferred to minimize non-uniformity during tapping down.

Thermal conductivity is measured at equilibrium using a cell with a diameter of 110 mm and a height of 100 mm. A heat source in the form of a cylindrical heating element is hanged in the middle with controlled power supply. Insulation is present circumferential to the cylindrical heating element. At the outside, a metal can is present. The thermal conductivity of the material is obtained from the temperature difference (between hot/cold face temperatures) and heat transfer cross cylindrical section. An effective area for the heat transfer is calculated, and hot & cold face temperatures (HF, CF) are recorded. The thermal conductivity γ in mW/mk is calculated as γ=0.956 x Power supply/ΔT (HF-CF)-0.0036. This method has been developed by applicant in collaboration with the National Physical Laboratory (NPL) in the UK. The resulting values for the thermal conductivity are approximately 15% higher than those measured in accordance with ISO 8302.

Shrinkage is defined as dimensional shrinkage, based on average of length and width. The shrinkage is measured after a heat treatment of 24 hours at 900° C. or 1000° C. in high temperature furnace, and subsequent cooling down to room temperature. The cooling down occurs by switching off the furnace, typically in 30 minutes. Measurements are made with calibrated devices.

Bending strength of the panel is measured using a universal test machine with cross-head speed and calibrated load cell.

### Example 1

Microporous powder compositions were generating by mixing pyrogenic silica as insulation powder, an opacifier, a reinforcing fiber and a gypsum filler material, in accordance with Table 1. The pyrogenic silica had a specific surface area in the range of 200-250 m²/g as measured by the BET method and was hydrophilic. The amount of gypsum varied from 0 to 30%, and the amount of pyrogenic silica reduced accordingly, while the amount of opacifier remained fixed at 37%, all in weight percent. The gypsum material was a synthetic gypsum material with a purity of 96%. The material was gypsum dihydrate and was crystalline having needle-shaped crystals. The mean particle size (d50) as measured with laser diffraction (Malvern Mastersizer 3000 from Malvern Pananalytical) was 40 μm. The d10 was less 10 μm and the d90<300 μm. The opacifier was a conventional rutile (TiO2) opacifier. E-glass fibers with a length of 6 mm were used as reinforcing fibers. Panels of 300×300 mm size were prepared from the microporous powder composition according to the method specified in WO00/037389, which is herein included by reference.

TABLE 1
test compositions

| | Pyrogenic | | | Reinforcing |
|---|---|---|---|---|
| | silica | Gypsum | opacifier | fiber |
| Ref 1 | 60 | 0 | 37 | 3 |
| 1 | 55 | 5 | 37 | 3 |
| 2 | 50 | 10 | 37 | 3 |
| 3 | 45 | 15 | 37 | 3 |
| 4 | 30 | 30 | 37 | 3 |

The thermal conductivity at 400° C. was measured on the microporous powder composition. The shrinkage was measured on the panels after a heat treatment at 900° C. during 24 hours. These are key performance parameters for microporous insulation products, especially in the form of panels and insulation blankets.

TABLE 2
thermal conductivity and shrinkage for test compositions

| | | Shrinkage after 24 h |
|---|---|---|
| | Thermal conductivity | heat treatment at |
| | at 400° C. (mW/mK) | 900° C. (%) |
| Ref 1 | 30 | 1.5 |
| 1 | 32 | 1.5 |
| 2 | 33 | 1.6 |
| 3 | 34 | 1.9 |
| 4 | 37 | 2.1 |

The results indicate a gradual but slow increase in the thermal conductivity. Replacement of 25% of the pyrogenic silica by gypsum results in an increase in thermal conductivity of about 13%. Replacement of 50% of the pyrogenic silica by gypsum results in an increase in thermal conductivity of about 23%. The thermal conductivity remains well below 40 mW/mK for this 50% replacement (leading to 30 wt % gypsum content). It can be derived herefrom, that the gypsum content could be further increased, such as to about 40 wt % gypsum content, without passing the 40 mW/mK limit. An increase of the gypsum content without concomitant decrease in pyrogenic silica may be achieved by replacement of the rutile opacifier with a silicon carbide opacifier. In fact, an appropriate content of the silicon carbide opacifier is from 15-25 wt %, so that mixtures 25-40 wt % pyrogenic silica and 25-50 wt % gypsum are feasible.

The results on thermal conductivity are surprising, given the relatively high thermal conductivity of gypsum dihydrate. S. Manzello et al, Proc. Of 5th Int. Conference on Structures in Fire (SiF′08), 2008, pp. 656-665 (https://tsapps.nist.gov/publication/get pdf.cfm?pub_id=900117) specify a thermal conductivity at room temperature in the range of 250-300 mW/mK (virgin material) and at 400° C. in the range of 150-200 mW/mK for a gypsum board. The lower thermal conductivity at 400° C. is attributed to the dehydration of the gypsum in a first heating cycle.

The inventor believes, without desiring to be bound herewith, that the mutual ordering of the gypsum and the pyrogenic silica may provide an explanation therefore. In his understanding, the gypsum particles with their comparatively big size would be encapsulated by the pyrogenic silica (and the opacifier), similar to micelles in an emulsion. As a consequence, there would not be a direct path between gypsum particles. Rather any heat (in the form of molecular vibrations and/or radiation) would be transmitted via the microporous phase.

The results on shrinkage after a 24 hours heat treatment at 900° C. are likely even more surprising, as the shrinkage increases merely very slowly. Even a 50% replacement of the pyrogenic silica with gypsum leads to shrinkage of a 2.1%. This is well below the upper limit of 5% and also well below the most preferred limit of 3%. These results tend to confirm the inventor's understanding that there is a special microstructure. In fact, addition of other types of silica than pyrogenic silica in smaller amounts, of around 10%, already leads to a very significant increase in shrinkage after the heat treatment at 900° C.

### Example 2

Further tests were performed with slightly different microporous powder compositions. As a first change, the E-glass fibers were replaced by silica fibers of equal length. As a further change, the pyrogenic silica was replaced by pyrogenic alumina. This allows manufacture of microporous powder compositions with a higher thermal stability, as specified in EP1663907B1. The gypsum addition was herein limited to 5% by weight. The Details on the compositions are shown in Table 3. The opacifier, the pyrogenic silica and the gypsum were identical to those used in Example 1. Panels of 300×300 mm were prepared therefrom.

TABLE 3
further test compositions

| | | | | | | Silica/ |
|---|---|---|---|---|---|---|
| | Pyrogenic | Pyrogenic | | | E-glass | Alumina |
| | silica | alumina | Gypsum | Opacifier | Fibers | fibers |
| Ref | 60 | 0 | 0 | 37 | 3 | 0 |
| 1 | | | | | | |
| Ref | 60 | 0 | 0 | 37 | 0 | 3 |
| 2 | | | | | | (SiO2) |
| Ref | 0 | 60 | 0 | 37 | 0 | 3 |
| 3 | | | | (ZrSiO4) | | (AI203) |
| 1 | 55 | 0 | 5 | 37 | 3 | 0 |
| 5 | 55 | 0 | 5 | 37 | 0 | 3 |
| | | | | | | (SiO2) |
| 6 | 0 | 55 | 5 | 37 | 0 | 3 |
| | | | | (ZrSiO4) | | (AI203) |

The test compositions were characterized for their thermal conductivity at 400° C. (microporous powder composition, shrinkage of the panels after a 24 hours heat treatment and bending strength of the panels. The heat treatment was performed at 1000° C. This is a clearly stricter requirement. Table 4 shows the results.

TABLE 4
thermal conductivity, shrinkage and bending strength for test compositions of Table 3

| | Thermal | Shrinkage after 24 h | Shrinkage after 24 | Bending | Bending |
|---|---|---|---|---|---|
| | conductivity at | heat treatment at | h heat treatment | strength | strength |
| | 400° C. (mW/mk) | 900° C. | at 1000° C. | (kPa) | decrease (%) |
| Ref 1 | 30 | 1.5 | - | 100 | - |
| Ref 2 | 28 | - | 2.5 | 125 | - |
| Ref 3 | 28 | - | 3.2 | 180 | - |
| 1 | 32 | 1.5 | - | 76 | 24% |
| 5 | 29 | - | 3.0 | 110 | 12% |
| 6 | 28 | - | 3.6 | 150 | 17% |

It is apparent from Table 4, that the applied changes do not lead to a significantly different behaviour of the resulting microporous powder compositions. The thermal conductivity at 400° C. is lower for both the reference compositions Ref 2 and Ref 3 and for the corresponding compositions 5 and 6. The increase in thermal conductivity by 5% addition of gypsum for the composition with silica fibers and for the alumina-based composition turns out low.

The shrinkage figures are higher, but this is due to the stricter requirements. If a test had been done at 900° C., the figures would have been equal or better to those listed in Table 2. The bending strength is higher for the compositions with silica fibers and based on alumina. The decrease in bending strength is smaller, both absolutely and relatively. It can be observed that the bending strength decrease is the least for composition 5, which comprising silica fibers. The bending strength is not deemed a critical parameter, since the microporous powder compositions in a panel or blanket are encapsulated.

If nevertheless better values for the bending strength would be desired, this can thus be achieved by means of the type and content of fibers, the length of the fibers, the mean size of the gypsum filler (somewhat smaller will be better), and/or by addition of a porous filler, such as the synthetic xonotlite known from WO00/37389A1. Alternatively or additionally, a mica sheet could be added, such as specified in WO00/37388A1. Said WO-applications are herein included by reference.

Thus, in summary, the invention relates to microporous powder composition, comprising an insulation powder chosen from alumina and silica, and an opacifier, a reinforcing fiber and a filler, wherein the filler is a gypsum material. The gypsum material may be gypsum dihydrate, gypsum hemihydrate or gypsum anhydrite. It may be synthetic gypsum or natural gypsum or a combination of both. The microporous powder composition comprises the opacifier in an amount of 10-50 wt %, the insulation powder in an amount of 40-80 wt % and the filler in an amount of 1-50 wt %. The microporous powder composition is used in insulation products. The reinforcing fiber is present in amounts of up to 10 wt %, preferably up to 5 wt %, such as 2-4 wt %.

1. A microporous powder composition, comprising an insulation powder chosen from alumina and silica, an opacifier, a reinforcing fiber and a filler, wherein the filler is a gypsum material.

2. The microporous powder composition as claimed in of claim 1, wherein the filler is a gypsum dihydrate.

3. The microporous powder composition of claim 1, wherein the gypsum is crystalline.

4. The microporous powder composition of claim 1, wherein at least part of said crystalline gypsum is needle-shaped.

5. The microporous powder composition of claim 1, wherein the filler is present in an amount of 1 to 50 weight percent, based on total dry weight of the microporous powder composition.

6. The microporous powder composition of claim 5, wherein the filler is present in an amount of 10 to 25 weight percent, based on total dry weight of the microporous powder composition.

7. The microporous powder composition of claim 1, wherein the gypsum filler has a mean particle size (d50) in the range of 10-100 μm, as measured by laser diffraction.

8. The microporous powder composition of claim 1, wherein the gypsum filler has particles with an aspect ratio of length to width from 1 to 5.

9. The microporous powder composition of claim 1, wherein at least 80 wt %, of the insulation powder is selected from pyrogenic silica and pyrogenic alumina.

10. The microporous powder composition of claim 9, wherein the insulation powder is pyrogenic alumina.

11. The microporous powder composition of claim 9, wherein the insulation powder is pyrogenic silica.

12. An insulation product in the form of a panel or insulation blanket comprising the microporous powder composition of claim 1 that is encapsulated in an envelope.

13. Use of the microporous powder composition of claim 1 for the manufacture of an insulation product.

14. The microporous powder composition of claim 2, wherein the gypsum dihydrate filler has a purity of at least 80% by weight.

15. The microporous powder composition of claim 7, wherein the gypsum filler has a mean particle size (d50) in the range of 25-75 μm.

16. The microporous powder composition of claim 7, wherein the gypsum filler has a mean particle size (d50) in the range of 30-50 μm.

17. The microporous powder composition of claim 8, wherein the gypsum filler has particles with an aspect ratio of length to width from 1 to 3.

18. The microporous powder composition of claim 9, wherein at least 90 wt % of the insulation powder is selected from pyrogenic silica and pyrogenic alumina.

19. The microporous powder composition of claim 11, wherein the pyrogenic silica is present in an amount of 40 to 80 weight percent, based on total dry weight of the microporous powder composition.

20. The insulation product of claim 12, wherein the microporous powder composition is in a compressed or compacted form.
